(19) United States
(12) Patent Application Publication
(10) Pub. No.: US 2019/0026669 A1
(43) Pub. Date: Jan. 24, 2019

(54) METHODS, SYSTEMS, AND DEVICES FOR PRODUCING VIDEO PROJECTS

(71) Applicant: FILMIO, INC., San Diego, CA (US)

(72) Inventors: Christopher J. Davis, San Diego, CA (US); Don Richmond, San Diego, CA (US); Corey Hertz, San Diego, CA (US); Bob Giargiari, Del Mar, CA (US); Bryan Hertz, San Marcos, CA (US); Kevin Hertz, Escondido, CA (US); Ian LeWinter, San Diego, CA (US)

(21) Appl. No.: 16/038,104

(22) Filed: Jul. 17, 2018

Related U.S. Application Data
(60) Provisional application No. 62/633,458, filed on Feb. 21, 2018.
(60) Provisional application No. 62/533,955, filed on Jul. 18, 2017.

(51) Int. Cl. G06Q 10/06; G06Q 30/08; G06F 21/62; G06F 17/30; H04L 9/06

(52) U.S. Cl. CPC G06Q 10/06313; G06Q 30/08; G06F 21/6218; H04L 9/0637; G06F 17/30194; G06F 17/30185; G06F 17/30991

(57) ABSTRACT

An embodiment comprises a method of managing a project. The method comprises storing information, received from a first user via a first user device, regarding a first media project in a first database based on account information provided by the first user. The method also comprises selectively permitting, via a first interface, the second user to identify an action to perform for the first media project, wherein the action includes viewing the first media project or providing one of financial support, creative input, creative services, and property to the first media project and providing a prompt to the first user regarding the action identified by the second user. The method further comprises, when the first user accepts the action identified by the second user, storing data in the first database regarding the identified action to perform relative to the first media project and tracking the first media project within a life cycle including three stages and upon determining that the first media project is in a third stage of the life cycle, distributing records from the first database regarding the first media project for a third user to receive.

### CROSS-REFERENCE TO RELATED APPLICATIONS

This application claims the benefit of priority to U.S. provisional Patent Application No. 62/533,955, filed Jul. 18, 2017, entitled “METHODS, SYSTEMS, AND DEVICES FOR PRODUCING VIDEO PROJECTS” and U.S. provisional Patent Application No. 62/633,458, filed Feb. 21, 2018, entitled DATABASE SYSTEM FOR DYNAMICALLY GENERATING CUSTOMIZED MODELS, each of which is hereby incorporated by reference herein in its entirety.

### FIELD

The present disclosure relates generally to creating, maintaining, and managing interconnections between a plurality of systems and devices on a network to facilitate the creation of a project. More particularly, the present disclosure relates to a platform system for connecting a plurality of devices together to facilitate the creation of an entertainment project.

### SUMMARY OF THE DISCLOSURE

The systems, methods, and devices described herein each have several aspects, no single one of which is solely responsible for its desirable attributes. Without limiting the scope of this disclosure, several non-limiting features will now be described briefly.

Embodiments of the present disclosure relate to a project management system (also herein referred to as “the system”) for creating, maintaining, and managing project data. The project processing system comprises a hardware processor configured to execute computer-executable instructions. The processor stores information, received from a first user via a first user device, regarding a first media project in a first database based on account information provided by the first user and provide a first interface configured to selectively permit the second user to identify an action to perform for the first media project, wherein the action includes viewing the first media project or providing one of financial support, creative input, creative services, and property to the first media project. The processor also provides a prompt to the first user regarding the action identified by the second user and when the first user accepts the action identified by the second user, store data in the first database regarding the identified action to perform relative to the first media project. The processor also tracks the first media project within a life cycle including three stages and upon determining that the first media project is in a third stage of the life cycle, distributes records from the first database regarding the first media project for a third user to receive.

Another embodiment comprises a method of managing a project. The method comprises storing information, received from a first user via a first user device, regarding a first media project in a first database based on account information provided by the first user. The method also comprises selectively permitting, via a first interface, the second user to identify an action to perform for the first media project, wherein the action includes viewing the first media project or providing one of financial support, creative input, creative services, and property to the first media project and providing a prompt to the first user regarding the action identified by the second user. The method further comprises, when the first user accepts the action identified by the second user, storing data in the first database regarding the identified action to perform relative to the first media project and tracking the first media project within a life cycle including three stages and upon determining that the first media project is in a third stage of the life cycle, distributing records from the first database regarding the first media project for a third user to receive.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of disclosure.

FIG. 1 illustrates a high-level overview of an example networked system for producing a video project.

FIG. 2 illustrates an example functional block diagram of an exemplary communications network system.

FIG. 3 illustrates an example functional block diagram of a communication device.

FIG. 4 illustrates an example schematic block diagram of content parameters for generating a project hosted on a project creation system.

### DETAILED DESCRIPTION

Various aspects of the systems, apparatuses, and methods are described more fully hereinafter with reference to the accompanying drawings. The teachings of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In general, in the production and creation of entertainment, such as movies and television programs, the viewing public has little to nothing invested and no input in the production. Large production studios and filmmakers in Hollywood make these determinations and receive returns on these productions. Accordingly, the public has little invested in the content they watch at home via television or over the Internet or what is presented in movie theaters. However, the unpredictable nature of viewer consumption and preferences has shown that studios invest and produce numerous programs that fail to connect with the public, resulting in wasted resources that may be distributed elsewhere.

Recently, advances in computer technology and changes in the law have made it easier for individuals to partake in the production of such programs. Each term may refer to the collective effort of individual investors who pool resources together in order to support efforts initiated by other people or organizations in exchange for returns and an ability to provide input into the effort.

Embodiments of the invention relate to an electronic platform for creating, maintaining, and managing the creation and distribution of a project. The project may include creative content, such as a movie or video. The platform may provide the necessary interconnections between devices on a network to facilitate creation, production, and distribution of a project. For example, a first user on the platform may have an idea for a movie or television program project. The first user may use the platform to upload a video presentation, slides, or description of the project to other interconnected users. The interconnected users may be, for example, fans or investors, who may provide financial support as well as input and services to further the creation of the project. Thus, the platform allows other users, who traditionally were only able to view programs, to have access to invest or provide input on the creation of the project.

Definitions:

Browser and Web Page: A browser is a computer program that provides functionality to a computer for executing syntax contained in web pages. The computer may be connected to a computer network, and the network may be, and usually will be, the Internet. As used herein, browsers and web pages together provide functionality to a computer connected to the network (e.g. the Internet) at least sufficient to request, retrieve, and display at least some network resources including web pages themselves, and to execute at least some links contained within or referred to in retrieved web pages to retrieve other web pages specified with the links. Browsers may operate together with browser extensions, and in this case, the combination may be referred to herein as a browser, without specific additional mention of the browser extension. Web pages may include references, such as URLs, to other network resources that contain images or other data that is retrieved by the browser from the network or a cache memory when executing the web page, and may also include references to programs, libraries, style sheets, scripts, and the like which are called by the browser when executing the web page. Some of these items may require prior separate loading onto the computer (e.g. Flash and a Java Virtual Machine). Any of these items that are accessed, used, and/or retrieved during browser execution of web page syntax are considered to be included as a component of the “web page” as that term is used herein. Examples of browsers include Internet Explorer distributed by Microsoft, and Chrome distributed by Google. Example web page syntax that can be executed by browsers is the various versions of HyperText Markup Language (HTML) promulgated by the World Wide Web Consortium (W3C).

Server: Processing hardware coupled to a computer network having network resources stored thereon that is configured with software to respond to client access requests to use or retrieve the network resources stored on the server.

Network Resource Identifier: A definition of a network resource (e.g. by storage location and filename) that is used by client computers to specify a network resource in access requests issued to the network by the client computers. A network resource identifier may also be referred to as a location of a network resource such as an image or a web page. Currently, when the network is the Internet, network resource identifiers may be referred to as URLs (an acronym for Uniform Resource Locator) that are formatted in accordance with RFC 3986 of the Internet Engineering Task Force (IETF). For the purposes of this disclosure, any format for specifying a network resource in client access requests issued to a network is within the definition of the term Network Resource Identifier. A network resource identifier, including URLs as currently defined on the Internet, may further include data in addition to data identifying the network resource that a server hosting the network resource associated with the network resource identifier may use for other purposes beyond identifying the requested network resource.

Web Server: A server that includes functionality for responding to requests issued by browsers to a network, including, for example, requests to receive network resources such as web pages. Currently, browsers and web servers format their requests and responses thereto in accordance with the HyperText Transfer Protocol (HTTP) promulgated by the IETF and W3C.

Link: Syntax that instructs a browser executing the syntax to access a network resource defined directly or indirectly by the syntax. The link syntax and/or internal browser functionality may also define conditions under which the access request is made by the browser, for example through cursor position and/or other interaction with an 110 device such as a keyboard or mouse. Some link syntax may cause the browser to access the specified network resource automatically while processing the syntax without user prompt or interaction. Links include HTML hyperlinks. A link may be directly coded with, for example, HTML tags and an explicit URL, or may be in the form of a script or other called function defined in a browser, in a browser extension, and/or in a web page.

Network Resource: A web page, file, document, program, service, or other form of data or instructions which is stored on a network node and which is accessible for retrieval and/or other use by other network nodes.

Project: As used herein, a “project” may refer to a video project, a movie, television program, web-series, streaming video, web television, music, story, a series of image files, a text file, an audio file, a series of video files, a drawing file, or other entertainment medium. While the present disclosure is made in reference to movies and other video-based projects, other projects are envisioned within the scope of this disclosure, for example, construction and structural projects, artistic projects, written projects, books, stories, video games, board games, etc., or any combination thereof. It will be appreciated that the present disclosure is not limited to entertainment media and projects; a project may refer to any undertaking proposed by a user of the systems and devices described herein.

Creator(s): A “creator,” as used herein, refers to a user of the system who proposes and uploads a project to the systems as described herein. A creator may have an idea or concept for a project. The creator may wish to develop and produce the project and is seeking investors, providers, and vendors to assist with developing the project. Thus, the creator may utilize the systems and devices described herein to connect with other users to facilitate the production of the project.

Fan(s): A “fan,” as used herein, is any user of the system. A “fan” may seek to view projects hosted by the systems described herein by accessing the web pages associated therewith. A “fan” may be an investor, provider, creator, and vendor. Fans, as used herein, may be any user seeking to interact with, view, and otherwise exhibit interest in one or more project web pages hosted by the systems described herein.

Investor(s): An “investor” is may be individual investors, accredited investors, non-accredited investor, and the like. An investor may be any entity or individual that seeks to invest in a particular video project.

Provider(s): A “provider” may be any individual or entity that may assist with the production and distribution of a project. In the context of movies, “providers” may refer to individuals with know-how or access to persons to assist with the brining a concept through production and distribution into a finalized movie (e.g., filmmakers). For example, such individuals, without limitation, may be producers, screen-play writers, directors, videographers, etc.

Vendor(s): A “vendor” is any individual or entity having products or property for inclusion in a project (e.g., as product placement). For example, an automobile manufacture may seek to offer products for use in producing a project for advertisement in the form of product placement. Other products are possible. Similarly, owners or agents of owners with control of locations and destinations, such as but not limited to, property, hotels, landmarks, etc. may be offered for use in a project.

Blockchain/Distributed ledgers: A “blockchain” or “distributed ledger” is a list of records, e.g., blocks, which are linked and secured using cryptography and which may grow as additional records are added to the list. The blocks generally include records of previous blocks, time information, and transaction information or data. Each blockchain is generally distributed, generally providing unilateral resistance to modification or corruption of data contained in the blockchain or any blocks therein. The blockchain may generally provide a distributed ledger that can be used to permanently record information of transactions such that they are easily and publicly verifiable. When used in a distributed ledger, a blockchain may be managed by a peer-to-peer network that utilizes a specific protocol or protocols for validating new blocks and providing permission to the information in the blockchain. Generally, data stored in the blocks of the blockchain cannot be altered retroactively without the alteration of all subsequent blocks.

Example Networked Communication System

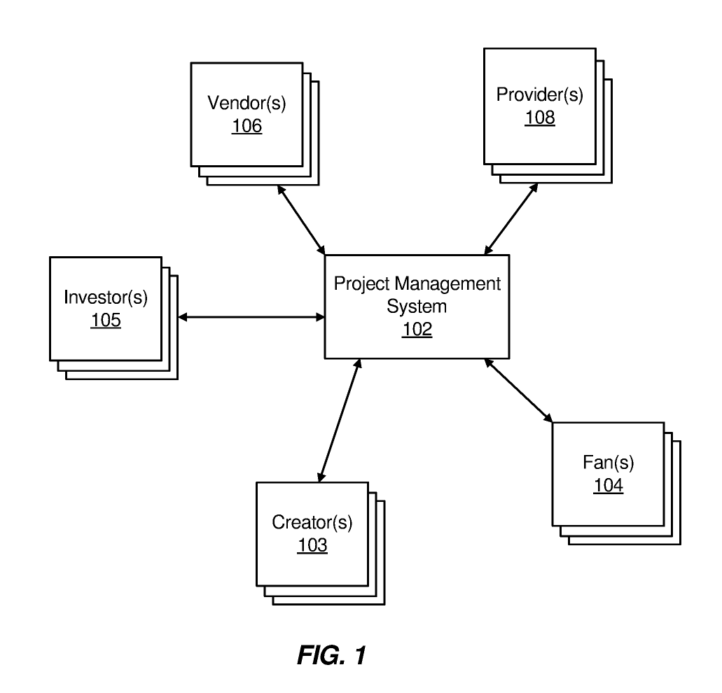

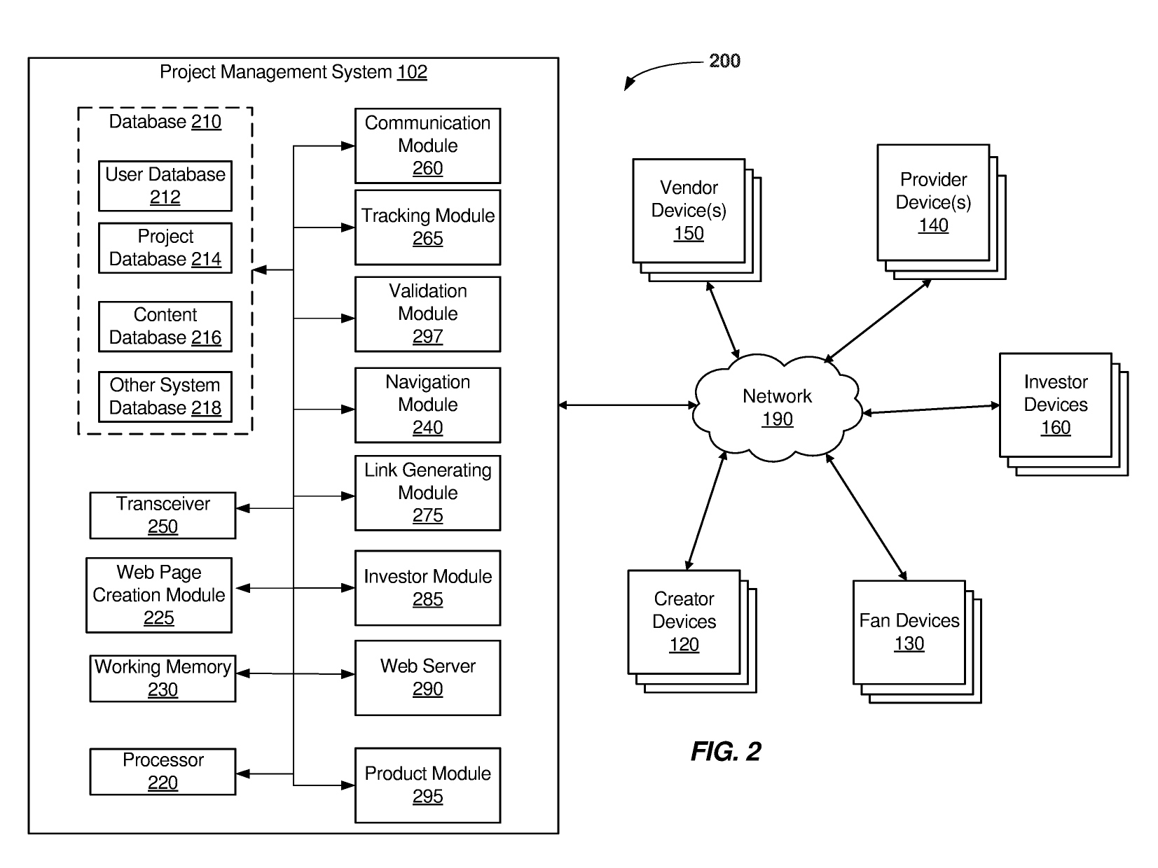

FIG. 1 illustrates a high-level overview of an example networked system for producing a video project. FIG. 1 is a block diagram depicting one embodiment of a networked system as described herein, for example, a project management system or project processing system 102. The project management system 102 may be configured to electronically interact with a plurality of different entities. For example, the project management system 102 may communicate with creators 103, fans 104, investors 105, vendors 106, and providers 108. Each entity can log on to the project management system 102 using an access device (e.g., FIG. 2) through a web browser in order to input data and/or access data from the project management system 102. It will be appreciated that, while a single entity of each type is discussed, more entities of each type may be included, for example, a plurality of creators 103, fans 104, investors 105, etc. In an embodiment, the project management system 102 can be configured to interact with creators 103. For example, creators 103 can log on to the project management system 102 using the access device (e.g., FIG. 2) comprising a web browser in order to input data and/or access data from the project management system 102.

In an embodiment, the project management system 102 can be configured to interact with creators 103. The project management system 102 can be configured to allow creators 103 to access the system through a web browser that allows creators 103 to post projects or other project investment opportunities to the system 102. For example, the creators 103 may create a personal web page representative of the project and the web page may be hosted by the project management system 102. The web page may comprise images related to the project (e.g., one-sheets, posters, etc.), textual information describing the project and/or persons involved, a status of the project, videos related to the project (e.g., trailers, informational videos, etc.), and other media.

In an embodiment, the project management system 102 can be configured to interact with fans 104. In an embodiment, the project management system 102 can allow fans 104 to access the system via a web browser in order to peruse and/or search web pages of projects hosted by the project management system 102. In an embodiment, the project management system 102 can be configured to allow fans 104 to interact with the web pages, for example, by reviewing data contained therein and or executing hyperlinks. In an embodiment, the web page of a project may include buttons that activate hyperlinks allowing a fan 104 to interact with a selection functionality.

In one example, the fans 104 may select an interest level in the project, for example, by selecting whether they would “watch”, “invest”, “watch and invest”, or “do nothing” with respect to a particular project. In this way, the fan can express interest in a particular project. The selection functionality may not be indicative of an actual action taken by the fan (e.g., the fan may not actually invest and/or watch). However, the fans' selection may be correlated by the creators to determine an interest level in their project. The project management system 102 may include a database for tracking of the fans' activity and ranking of a particular project. In an embodiment, the project management system 102 can allow a fan 104 to subscribe or be otherwise associated with a project (e.g., following a project). The project management system 102 can generate notifications and updates concerning the project that are transmitted to the fan 104. In an embodiment, the project management system 102 can be configured to store data of activity of the fans 104 within the project management system 102. In an embodiment, the project management system 102 can be configured to analyze the data of the fans 104 in order to generate an activity level or other indication of how active the fan 104 was in project management system 102. In an embodiment, the project management system 102 can be configured to provide a direct communication pathway to the other users of the project management system 102 based in part on the activity level of a fan 104.

In an embodiment, the project management system 102 can be configured to interact with providers 108. In an embodiment, the project management system 102 can allow providers 108 to access the system via a web browser in order to peruse and/or search web pages of projects hosted by the project management system 102. For example, providers 108 may interact with the project management system 102 to peruse project web pages and transmit data indicative of an offering of services to facilitate the production of a project. In an embodiment, the project management system 102 can be configured to allow providers 108 to post service opportunities on the system. For example, similar to creators 103, the providers 108 may create personal web pages representative of the services that may be used by creators to develop and produce the project.

In an embodiment, the project management system 102 can be configured to interact with vendors 106. In an embodiment, the project management system 102 can allow vendors 106 to access the system via a web browser in order to peruse and/or search web pages of projects hosted by the project management system 102. For example, vendors 106 may interact with the project management system 102 to peruse project web pages and transmit data indicative of an offering of products and/or destinations for product placement opportunities. In an embodiment, the project management system 102 can be configured to allow vendors 106 to post products and/or destinations on the system. For example, similar to creators 103, the vendors 106 may create personal web pages representative of the products and/or locations that may be used by creators in projects.

In an embodiment, the project management system 102 can be configured to interact with investors 105, either individuals or entities. In an embodiment, the project management system 102 can allow investors 105 to access the system via a web browser or other access device in order to peruse data relating to projects available and/or presented on the project management system 102. In an embodiment, the project management system 102 can be configured to store data of investments made by the investors 105. In an embodiment, the project management system 102 can be configured to analyze the data of the investors 105 in order to generate an activity level or other indication of how active the investor 105 was in project management system 102.

It will be appreciated that any given user or individual may be considered to be one or more entities depending on the functions of the project management system 102 being utilized by each individual. For example, a fan 104 may also be an investor 105 if the fan seeks to invest as well as follow a project uploaded in the project management system 102. Similarly, a vendor 106 may also perform functions on the project management system 102 such that the vendor 106 may be a fan 104 as well. Other possibilities and configurations are envisioned within the scope of this disclosure.

Example Networked Communication System

FIG. 2 illustrates an example functional block diagram of an exemplary communications network system. FIG. 2 depicts a high-level overview of a networked communication system 200 comprising the project management system 102 configured to interact with a plurality of users through user devices connected by a network 190. While the following description is made in reference to wireless communication over the network 190, the various components illustrated in FIG. 2 and throughout this disclosure may be in wired or wireless communication.

In an embodiment, the project management system 102 may comprise one or more processors 220 operatively connected to a working memory 230, one or more non-transitory databases 210, and web server 290. The database 210 may comprise a plurality of databases, including but not limited to, a user database 212, a project database 214, a content database 216, and additional database 218. The user database 212 may be configured to store data associated with the users of the project creation system, for example, the user database 212 may separately store data associated with each creator(s), fan(s), vendor(s), investor(s), and provider(s).

In some embodiments, the processor 220 may be configured for use with or implementation of a blockchain or distributed ledger system. For example, the processor 220 may store a local copy of a blockchain or a distributed ledger (“local copy”) in a blockchain or distributed ledger database (not shown in this figure). For example, the local copy may be stored in the database 210. The processor 220 may commit, post, or save one or more pieces of information to the local copy or the blockchain by adding a new entry or record to the local copy or the blockchain. Accordingly, the processor 220 may generate new records within the local copy or in the blockchain or the distributed ledger. In some embodiments, the processor 220 may synchronize the local copy with the blockchain or the distributed ledger. Such synchronization may occur automatically any time the processor 220 has access to the Internet or on a scheduled basis. In some embodiments, the processor 220 may store add new entries or records to the local copy or the blockchain for any transaction related to a project in the database 210 or the project database 214 or otherwise associated with the project creation system 102. For example, the processor 220 may store information regarding financial investments provided by an investor to a particular project in the local copy or the blockchain associated with the particular project. Similarly, the processor 220 may store information in the local copy or the blockchain associated with the particular project regarding providers that provide a service to the particular project and/or vendors that provide property for use in the particular project. In some embodiments, each accessing of the particular project (for example, each viewing, and so forth) generates new records in the local copy or the blockchain associated with the particular project. Accordingly, the local copy or the blockchain may provide a single source for all records and/or transactions associated with the particular project.

In some embodiments, the working memory 230 may be utilized by the processor 220 to store data dynamically created during operation. For example, instructions from any of the modules or databases 210 may be stored in working memory 230 when executed by the processor 220. Thus, the processor 220 may store information regarding projects received from creators to the project database 214 and/or the content database 216. Similarly, the processor 220 may store corresponding information to any other database discussed herein. The working memory 230 may also store dynamic run time data, such as stack or heap data utilized by programs executing on the processor 220.

The databases 210 may be utilized to store data created the project management system 102. The databases 210 may include both read-only memory (ROM) and random access memory (RAM) configured to store, at least for example, instructions, software, and the audiovisual content. The databases 210 can be used to store digital files, e.g., a DCP, software, executable instructions, configuration settings, calibration information, audiovisual content files, access parameters, and the like. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). A portion of the databases 210 may also include non-volatile random access memory (NVRAM). Further, in some embodiments, the databases 210 can comprise a plurality of hard drives, such as those operating under a RAID protocol. However, any type of storage device can be used.

In some embodiments, the project database 214 may be configured to store data associated with the projects and which may be transmitting data representative of the web page to a web browser. In some embodiments, the content database 216 may be configured to store data locally within the project management system 102, for example, video files, image files, etc. In some embodiments, the database 218 may comprise, among other things, a plurality of modules that store data values defining instructions, that when executed, configure the processor 220 to perform the functions of the project management system 102, as described below. In some embodiments, the project database 214 and the content database 216 may be combined into a single database (for example, the project database 214 may include the data of the content database 216). The project management system 102 may comprise general purpose processing hardware and may be a single computer or may be distributed among multiple different computers.

User devices may include, but are not limited to, creator devices 120, fan devices 130, provider devices 140, and vendor devices 150 (sometimes referred to herein as “user devices”). It will be appreciated that, while a single user device of each type is discussed, the system may include a plurality of each type of device connected to the project management system 102. In some embodiments, a creator 103 (FIG. 1) may operate a creator device 120; a fan 104 may operate a fan device 130, a vendor 106 may operate a vendor device 150; and so on.

The network 190 may include a wide area network (WAN), metropolitan area network (MAN), local area network (LAN), wireless local area network (WLAN), or personal area network (PAN) which may be or may be connected to the Internet. Although shown as one network, the network 190 may include several interconnected networks. The networks which may be included in the networked communication system 100 may differ according to the switching and/or routing technique used to interconnect the various network nodes and devices (e.g., circuit switching vs. packet switching), the type of physical media employed for transmission (e.g., wired vs. wireless), and the communication protocols used (e.g., Internet protocol suite, SONET (Synchronous Optical Networking), Ethernet, etc.). Regardless of the form the network 190 may take, the network 190 is configured to facilitate machine-to-machine messaging for tagging and communication as described herein.

In an embodiment, the project management system 102 may generate, host, and facilitate interaction with web pages associated with a particular user as described below. For example, a user may access the project management system 102 via network 190 through a browser running on a given user device to generate a web page containing user defined project. In some embodiments, the operator of the project management system 102 may define certain parameters for constraining the type of project, format of the web page, and guidelines for generating the web page.

In an embodiment, the content project management system 102 may comprise a web page creation module 225. In some embodiments, the web page creation module 225 may include instructions, that when executed, cause the processor(s) 220 to generate a web page associated with a project. For example, the web page creation module 225 may receive data from a creator device 120 for generating a web page associated with a project.

In an embodiment, the content project management system 102 may comprise a navigation module 240. In some embodiments, the navigation module 240 may include instructions, that when executed, cause the processor(s) 220 to manage the navigation of user devices within the project management system 102. For example, a fan device 130 may send data to the project management system 102 requesting a web page associated with a given project. In response to a request from a user device, instructions in the navigation module 240 may cause the processor 220 to retrieve a requested web page for presentation on the user device.

In an embodiment, the content project management system 102 may comprise a communication module 260. In some embodiments, the communication module 260 may include instructions, that when executed, cause the processor(s) 220 to manage communications between user devices (e.g., the fan device 130 and creator device 120, the investor device 160 and the creator device 120, etc.) and/or the project management system 102. For example, the communication module 260 may receive communications from one or more of the user devices and receive information from the user devices. In some embodiments, the communication module 260 may include one or more circuits that communicate over a network to enable communications between the user devices and/or the project management system 102. Thus, the communication module 260 may provide access for the user devices to the project management system 102.

In an embodiment, the content project management system 102 may comprise a tracking module 265. In some embodiments, the tracking module 265 may include instructions, that when executed, cause the processor(s) 220 to track activity associated with users and/or projects with the project management system 102.

In an embodiment, the content project management system 102 may comprise a link generator module 275. In some embodiments, the link generating module 275 may include instructions, that when executed, cause the processor(s) 220 to generate a unique network resource identifier based in part on the activity associated with users and/or projects. In an embodiment, activity associated with the unique network resource identifier may be used by the tracking module 265.

In an embodiment, the content project management system 102 may comprise an investor module 285. In some embodiments, investor module 285 may include instructions, that when executed, cause the processor(s) 220 to provide opportunities and manage investments in projects associated with web pages. For example, the investor module 285 may receive data from an investor device 160 via a web page associated with a project. The data may be representative of an investment in the project associated with the web page. The investor module 285 may include instructions for managing these investments and returns and correlating investments with users and/or projects.

In an embodiment, the content project management system 102 may comprise a product module 295. In some embodiments, product module 295 may include instructions, that when executed, cause the processor(s) 220 to generate, receive, store, or provide a listing of products that a vendor may be capable of providing for use or consumption in one or more projects. For example, the vendor may be a car dealership that is willing to provide vehicles for use in projects that are produced, or that would use the vehicles, within a specific geographic region (e.g., an area serviced or targeted by the car dealership). Thus, in some embodiments, the product module 295 may store a listing of products associated with the vendor for searching or viewing by other users. Accordingly, the vendor module 295 may track associations between product offerings and the particular vendor that is offering the product(s) and allow other users to identify a particular vendor based on a particular product need. In some embodiments, the product module 295 may manage a database of products for searching by users. In other embodiments, the products may be provided by retail locations, such as restaurants, stores, malls and other businesses wishing to advertise their goods or services by participating in a project.

In some embodiments, the product module 295 may establish an “auction” type listing or site for each project in the project management system 102, where the auction listing or site comprises a listing of products needed for a particular project. Based on that listing, vendors may “bid” on products needed. For example, if a project generates a listing identifying a need for luxury vehicles for a particular duration, different luxury vehicle vendors could “bid” or offer their products for the project (e.g., a first luxury vehicle vendor may offer three luxury vehicles for use in the project for two days each while a second luxury vehicle vendor may offer five luxury vehicles for use in the project for one week each). The creator or other entities managing the project may then select one or more of the vendors based on the bids that are most “in line with” the needs of the project.

In some embodiments, the product module 295 may inform vendors of potential projects to which they could provide products based on a matching of a product needed for a project (as identified by the project listing) and a product that the vendor identifies as being available for use in the project. For example, the product module 295 may communicate with the vendor device 150 of the first luxury vehicle vendor identifying a project that needs a luxury vehicle when the first luxury vehicle vendor has expressed interest in providing luxury vehicles for use in projects. In some embodiments, project management system 102 may allow the first luxury vehicle vendor and the creator (or other managerial entities for the project) to create a relationship (and potentially a contract) that can be stored in the distributed ledger associated with the project. In some embodiments, the “auction” type listings may also be used by providers and investors to allow the providers and investors to “bid” or offer their services or funds on projects that may match with respective interests. For example, an investor device 160 may receive (for example, via a web page associated with a project or an alert) a notification that the project is requesting funding. The investor may review information regarding the project (for example, returns being offered based on particular investment amounts) and determine an amount to bid, if any, as an investor. The creator or entity managing the project may then select one or more bids from the received bids and the project management system 102 (for example, via the investor module 285) may communicate with the inventor device 160 to facilitate the management of these bid investments and returns with investors and/or projects.

In some embodiments, the product module 295 may be configured to integrate with the blockchain module 296 to track any transactions between the vendors and a project (e.g., to track when a vendor provides products to or for a project). For example, the product module 295 may provide information regarding a transaction between the vendor and the project to the blockchain module 296 for recording in a blockchain (e.g., a blockchain of the product). In some embodiments, any corresponding payments or transactions are based on a currency that is maintained by or within the project management system 102. In some embodiments, the currency may be a digital token.

In some embodiments, the content project management system 102 may comprise a validation module 297. In some embodiments, the validation module 297 may include instructions, that when executed, cause the processor(s) 220 to generate, receive, request, determine, store, or provide a validation of one or more projects. Validation may include or entail determining that a project can proceed from a first stage in a project development cycle to a second stage in the project development cycle. In traditional project management, the validation may be generally performed by accountants or other executives at a project production company. However, the content project management system 102 may provide for crowd sourcing the validation of a project.

Crowd sourcing the validation of projects may involve requesting or allowing fans, investors, etc., to assist in determining whether a particular project should be produced, released, etc. For example, various factors or variables may be used to generate a score for the project. Some of these factors or variables may be subjective while others are more objective. For example, some objective factors or variables may include an amount of money raised by fans or investors, a quantity of fans or investors, or an average investment amount per fan or investor. Some subjective factors or variables may include survey results from fans or investors regarding how much the fans or investors like the project or aspects of the project that the fans or investors like. Accordingly, the validation module 297 may be configured to identify the factors or variables and compute scores for the projects based on crowd sourced information to determine whether the corresponding project is validated. For example, the validation module 297 may determine the scores and compare it to a threshold to determine whether the corresponding project is validated or not.

In some embodiments, the validation module 297 may be configured to integrate with the blockchain module 296 to track any validations for the corresponding project. In some embodiments, blockchain records corresponding to the project may be updated based on the validation score. In some embodiments, fans, investors, etc., that assist in the validation process of a project may earn digital tokens that may be exchanged for services, goods, or access to projects within the content project management system. The digital tokens may be earned regardless of whether the project is ultimately validated or not. In some embodiments, the validation module 297 may work in conjunction with the processor 220 when synchronizing the local copy with the blockchain.

In some embodiments, the project management system 102 may “stage” projects in a plurality of stages or phases. After onboarding, projects may proceed through growth stages. The progression from one stage to the next may be based on various thresholds or accomplishments. The various stages may represent a path through the conceptualization, production, and distribution of a project. The stages may provide creators with a structured mechanism to grow their project from a concept and to build an audience and generate funding.

Each stage may correspond to a single period during which different actions may be taken with the project. In some embodiments, transitioning from one stage to another may be based on validation (as described herein) or may be based on a vote where a threshold number of votes is needed for participants in the project to transition the project from between the stages. In some embodiments, transitioning between stages may be based on attaining specific project thresholds (e.g., project completion for distribution). In some embodiments, the transitioning between stages may be based on a combination of one or more of validation, voting, and project thresholds.

In some embodiments the project management system 102 may include three stages for each project. For example, a first stage may include creating an account and filling out necessary account information. The account information may include details including a type of project (e.g., music, movie, etc.), a name of the project, a project creator, needed products, services, and/or roles (e.g., director, producer, etc.). In some embodiments, the first stage may include launching the project, which may involve adding the project to the project management system 102. The first stage may also include completing certain milestones (e.g., creating a project summary or a poster). Fans may be involved with the first stage by promoting or helping to “jumpstart” the project (e.g., social media advertising or promotion, etc.). The first stage may also include gathering votes, e.g., from fans. Once the project is set up and the project accrues sufficient votes, the project transitions to the second stage. In some embodiments, establishing the account information (e.g., creating the project within the project management system 102 may include an initial transition threshold or event before entering the first stage in the project life cycle).

The second stage may include all activities involved with actually developing the project, e.g., pre-production and production of the project. For example, the second stage may include funding, project scoring, and production of the project. Funding may include the tools and corresponding period where funds for producing the project are acquired, e.g., from investors, fans, etc. In some embodiments, the funding may be financial (e.g., donations, loans, etc.) or service driven (promises participation, etc.). In some embodiments, the project creator may issue tokens in return for financial or service contributions. The second stage may also include project scoring, which may be based on one or more deliverables of the project. For example, when the project is a movie, the project scoring may be based on a short trailer deliverable. When the project is music, the project scoring may be based on a clip of the music. The second stage may also include the production of the project. In some embodiments, the pre-production of the project may include the funding and project scoring phases of the second stage. The second stage may last until the project has been through both pre-production and production and is ready for distribution. During the second stage, all services provided may be exchanged for promises for payment at a later date (e.g., an “I owe you” (IOU)). Once the project is produced and development and creative components are complete (e.g., the project is complete), the project transitions to the third stage. In some embodiments, a determination of whether the project has met the completion threshold is determined by the vote of parties (e.g., the provider, vendors, or fans) involved in the project. If a threshold number of parties vote to transition to the next stage, the project transitions to a third stage. In some embodiments, the processor 220 may track the promises for payment through when the project transitions to the third stage and provide for proper accounting of the payments for completed services, etc. In some embodiments, instructions (for example, in one or more of the modules of the project management system 102) may be executed to cause the processor 220 to associate the payment information for services with a project web page and store the association in the project database 214 and/or user database 212. When the project is completed, instructions may also configure the processor 220 to calculate and distribute payments based on the promises for payment to the providers (for example, via respective provider devices 140). Similarly, payments to vendors based on promises for payment in return for property used in the project may be provided to the vendors.

In the third stage, the project may be completed and ready for distribution. The third stage may include distributing the project on the network 190 and providing the project for sale or licensing to or via third parties. In some embodiments, the project may be available for consumption by entities that donated funds or efforts or performed social media advertising and promotion. In some embodiments, the third stage may also include any licensing or sale transactions.

In some embodiments, the project management system 102 (e.g., the processor 220) may control the transition of projects between the stages in the project life cycle. In some embodiments, the control by the processor 220 may be based on the threshold events described here (e.g., voting thresholds, production completion, etc.).

In some embodiments, the processor 220 may generate one or more user interfaces in conjunction with the various modules described herein. For example, the processor 220 may generate a user interface that permits one of providers, investors, and fans to search for and/or browse for projects that are stored in the project database 214. In some embodiments, the user interface may comprise the web pages hosted by the project management system 102. In some embodiments, the interface may be a user interface by which the users interact with the project. For example, the processor 220 may generate a project explorer user interface (for example, the web page and web browser described herein) that permits the user to search for and access projects stored in the project database 214. In some embodiments, the project explorer user interface may permit the user to identify an action, etc., that the user may perform in relation to the project. For example, if the user is an investor, the project explorer user interface may permit the user to invest in the project or access investment information associated with the project. Similarly, if the user is a provider, the user to identify one or more services that the user can provide to the project or view information associated with services needed by or used by the project. Similarly, if the user is a fan, the project explorer user interface may permit the fan to view or review the project. Similarly, if the user is a vendor, the project explorer user interface may permit the vendor to identify property that the vendor will provide for the project or review property that the project needs. In some embodiments, the processor 220 may generate the user interface(s) to selectively control what options are available to a user based on whether the user is a vendor, an investor, a fan, a provider, and so forth.

In some embodiments, if the user identifies a service, investment, property, or other action to take with the project, the processor 220 may prompt the creator to accept the identified action and provide permission for the identified action. In some embodiments, data regarding the identified action and the creator's acceptance may be stored in the project database 214.

In some embodiments, the processor 220 may work in conjunction with one or more of the modules of the project management system 102 to provide corresponding user interfaces for use by the users via respective user devices.

The project management system 102 may be configured to allow transmission and reception of data from the project management system 102 and the network 190, such as for example user devices. For example, the project management system 102 may be configured to process, send, receive, construct, and/or interpret information over a network connection or physical connection. In an embodiment, the project management system 102 may include a transceiver 250 configured to facilitate wireless communication over the network 190 described herein. The transceiver 250 can be configured to receive data for storage and processing by the project management system 102. The transceiver 250 may be a single component or a separate transmitter and receiver (not shown). A single or a plurality of transceiver antennas may be attached to the project management system 102 and electrically coupled to the transceiver 250. The project management system 102 may also include (not shown) multiple transmitters, multiple receivers, and multiple transceivers. In some embodiments, the transceiver 250 may comprise the one or more circuits of the communication module 260 that enable communications over the network.

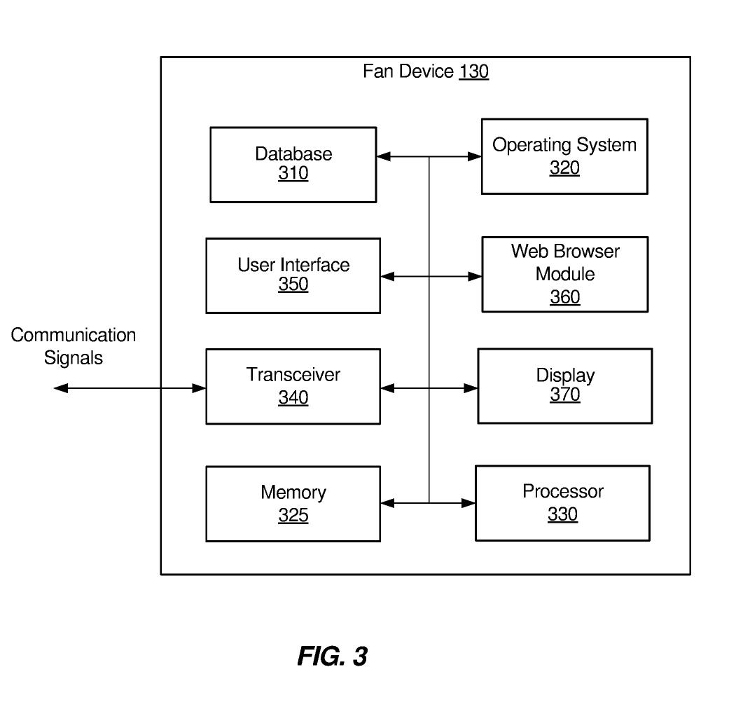

FIG. 3 illustrates an example functional block diagram of a fan device 130. However, it should be realized that a similar device could be used as the vendor device 150, provider device 140, investor device 160, or creator device 120. The fan device 130 may be employed within a communication network, such as the project creation system 200 of FIG. 2. In some embodiments, the fan device 130 may be any type of user device (e.g., a creator device 120, etc. of FIG. 2). The fan device 130 can include hardware and software sufficient to accomplish the functionality described herein. The fan device 130 may be configured to receive data from the project management system 102, assemble project web pages, and interact with the web pages via a web browser.

The fan device 130 may comprise general purpose processing hardware and may be a single computer or may be distributed among multiple different computers. The fan device 130 may include one or more processors 330 and a database 310, such as non-transitory computer storage. The database 310 may be similar to the database 210 described. In some embodiments, database 310 may be configured to be compartmentalized into a plurality of modules. In some embodiments, one of the modules may be an operating system 320. The operating system 320 may configure the processor 330 to manage the database 310 and the processing resources of the fan device 130 for various operational tasks. For example, operating system 320 may include device drivers to manage hardware resources to perform instructions to accomplish the functionality described herein, for example, managing the web browser via the web browser module 540. Instructions within operating system 320 may then interact directly with these hardware components.

The processor 330 can be configured to provide computational power and to direct and coordinate the execution of functions sufficient to provide the targeted and desired functionality of the fan device 130. The database 310 may be configured to provide instructions and data to the processor 330. The instructions, when executed by the one or more processors 330, may cause the processor to perform the various functions described herein. Accordingly, the processor may include, e.g., hardware, firmware, and software, or any combination therein.

The fan device 130 may be configured to allow transmission and reception of data between the fan device 130 and the network 190, such as for example the project management system 102. For example, the fan device 130 may be configured to process, send, receive, construct, and/or interpret information over a network connection or physical connection. For example, the fan device 130 may include a transceiver 320 to facilitate wireless communication over the network 190 described herein with reference to FIG. 2. The transceiver 340 can be configured to receive data for storage and processing by fan device 130. The transceiver 340 may be a single component or a separate transmitter and receiver (not shown). A single or a plurality of transceiver antennas may be attached to the fan device 130 and electrically coupled to the transceiver 340. The fan device 130 may also include (not shown) multiple transmitters, multiple receivers, and multiple transceivers.

The fan device 130 may further comprise a user interface 350 in some aspects. The user interface 350 may comprise a keypad, a microphone, a speaker, touchscreen, and/or the display 370. The user interface 350 may include any element or component that conveys information to a user of the fan device 130 and/or receives input from the user. In some embodiments, the user interface 350 may be included in the fan device 130 or may be remotely connect to the fan device 130.

The various components of the project management system 102 and the fan device 130 may be coupled together by a bus system, respectively, which may include a power bus, a control signal bus, and a status signal bus in addition to a data bus.

Each user of the project management system 102 may be associated with a user identifier stored in the user database 212. For example, the user may generate or be provided a username associated with a user identifier and a password for accessing the project management system 102. The username may be associated with a personal web page hosted by the project management system 102. For example, each user may supply inputs to the project management system 102, via the fan device 130, to generate a web page including project, data, and information associated with a particular user. In some embodiments, the user identifier may be associated with a particular user device and/or user. In some embodiments, the user database 212 may be configured to identify profiles with each creator, fan, vendor, investor, and provider and identify user devices associated with each profile. In some embodiments, the personal web page may be tied to the user profile for each respective user and may identify experience of the respective user, prior projects with which the respective user is associated, and so forth.

As described above in connection to FIG. 3, user devices may be configured to communicate with the project management system 102. As used herein, user devices may refer to a particular fan device 130, for example, a creator device 120 may be implemented as a fan device 130. In an embodiment, a creator device 120 may utilize a web browser module 360 to generate project web pages hosted by the project management system 102. The creator device 120 may access the project management system 102 to generate a web page, via instructions in the web page creation module 225, associated with the project craft beer reality show, including any information about the project.

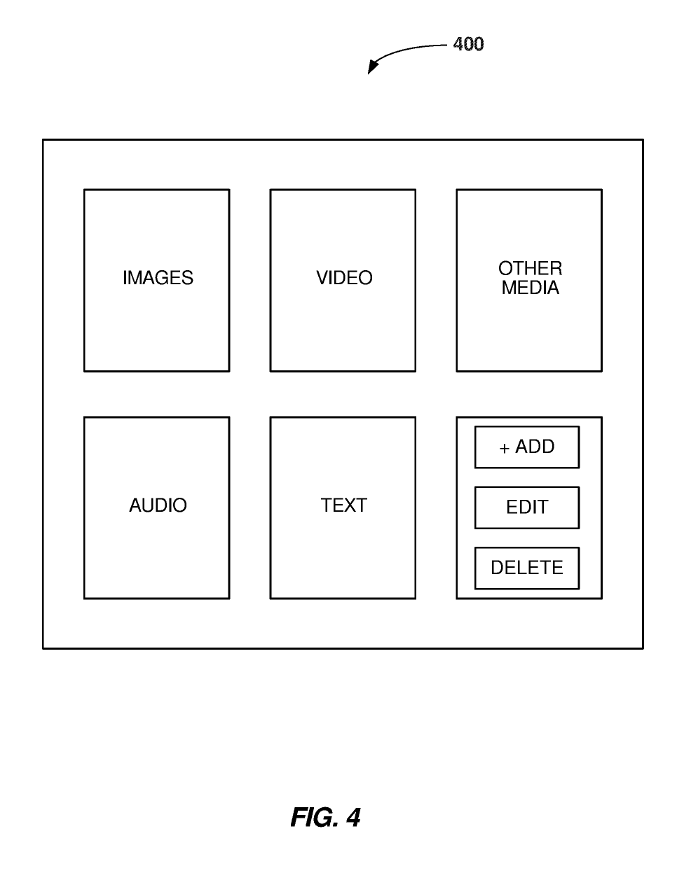

For example, FIG. 4 illustrates an example schematic block diagram of interface 400 for use input of content for a generating a project web page hosted on a project creation system. In an embodiment, the user of the creator device 120 may implement the interface 400 via instructions in the web page creation module 225. The interface 400 may permit the creator device 120 to input content within predefined parameters. Such parameters may be controlled by the operator of the project management system 102 to provide guidance as to the type of content and formatting of the content included in each project web page. The interface 400 may be implemented in the creator device 120 over the Internet via interaction between the web browser module 360 of the creator device 120 and the project management system 102. The interface 400 may be configured to provide adding, editing, and deleting of a variety of content. For example, the content parameters may be, but are not limited to, photographs, images, textual and written media, audio media formats, and video formats, among other digital media. The content may include videos, trailers, textual descriptions, images (e.g., a one-sheet or other images), audio files, and other media representative of the project. In some embodiment, the user may provide links associated with other resource destinations (e.g., databases, web pages, servers, etc.) that can be retrieved by the project management system 102 over the network 190, for example from web servers (not shown). In some embodiments, alternatively or in combination, the user may upload this content to the project management system 102, which may locally store the content in database 416 and host the content. In one embodiment, the user may be able to add, delete, or edit media uploaded by the user.

While the description is made with reference to a user operating a project creation device 110, other configurations are possible. For example, similar personal web page management nodes may be implemented by the fan device 130, provider device 140, and the vendor device 150 in accordance with their functions as described below.

In an embodiment, a fan device 130 may be configured to interact with the project management system 102 to generate personal web pages hosted by the project management system 102. The user of the fan device 130 may not have a project, but may be interested in viewing and interacting with project web pages hosted by the project management system 102. The user may access the project management system 102 to generate a web page associated with the user including information about the user. The information may include user preferences and interests (e.g., the types of projects that the user is interested in, specific genres, etc.), personal information (e.g., location), user activity levels indicative of the user's activity within the project management system 102 as described below, user identifiers and status indicators, among other information. In some embodiments, the information may be supplied by the user (e.g., preferences, interests, personal information, etc.) while other information is generated by the project creation system (e.g., user identifiers, activity ratings, etc.).

The fan device 130 may be configured to navigate to a project web page hosted by the project management system 102 as described below. Upon reaching a project web page, the fan device 130 may interact with the content included therein (e.g., the content described above in connection to FIG. 4). In some embodiments, a plurality of hyperlinks may be presented to the fan device 130. The hyperlinks may comprise a plurality of links each associated with a function configured to associate a level of interest with the project. This ranking may be stored in a database 414 with rankings by other fan devices 130. For example, four links may be presented giving the fan device 130 four options. In one implementation, the user of the fan device 130 may select (1) want to watch the final project; (2) financially support or invest in the project; (3) watch and support the project; or (4) none of the above (e.g., not interested in the project). Based on an aggregate of the selected options from a plurality of fan devices 130, a ranking may be determined for each project.

The fan device 130 may be configured to communicate with the project source 120 as described below or with any users of the project creation system 100. For example, the project management node 200 may include a linked function supplying a pathway for communicating directly with the creator device 120. In some embodiments, the pathway for communication includes providing an email address or telephone number for contacting the user of the creator device 120. In another embodiment, alone or in combination, the means for communication may open a conversation window or communication thread hosted by the project management system 102 for contacting the creator device 120. In some embodiments, the means for communication may be a linked function to upload a review or comment to the project web page which may be viewable by any user of the project management system 102.

The investor device 160 may be similar to the fan device 130. In addition, the investor device 160 may be configured to interact with the project management system 102 to generate personal web pages hosted by the project management system 102. The investor device 160 may be configured to navigate to a selected project web page, and interact with the content included therein. In some embodiments, the investor device 160 may transmit a request to invest in a particular project to the projection creation system 110 of the project management system 102. The request may comprise an amount to be invested, a project identifier, and an identification of the investor 160. Instructions in the investor module 285 may be executed to cause the processor to associate the investor device 160 with a project web page, and store the association in the project database 214 and/or user database 212. When the project is completed, instructions in the investor module 285 may also configure the processor to calculate and distribute returns on the investment to the investor device 160. Accordingly, in some embodiments, users operating a fan device 130 may also be a user operating an investor device 160, thereby permitting fans of projects to invest in and receive returns from projects.

The provider device 140 may be similar to the fan device 130. In addition, the provider device 140 may be associated with users who have the means to support or further production of the project. For example, the provider device 140 may generate a personal web page containing information about one or more components of taking a project from idea to completion. For example, in the context of movies, the creator device 120 may have only an idea, but one or more provider device 140 may be associated with users who can assist with development, production, and distribution of the finalized project. The provider device 140 may utilize the project management system 102 to search for, locate, and communicate with the creator device 120. The creator device 120 may utilize the project management system 102 to locate provider device 120, and vice versa.

The vendor device 150 may be similar to the fan device 130. In addition, the vendor device 150 may be associated with users who have the products or locations that may be used in the production of the project. For example, the vendor device 150 may generate a personal web page containing information about one or more products (e.g., soda, automobiles, etc.) or locations (hotels, destinations, etc.). The vendor device 150 may be seeking product placement opportunities within the project, and may utilize the project management system 102 to locate such opportunities. Similarly, the creator device 120 and/or the provider device 140 may be seeking product placement opportunities within a project. Accordingly, the project management system 102 may facilitate the navigation and communication between these devices.

As described above, instructions stored in the various modules of the project management system 102 may, when executed, configure the processor 220 to perform the functions of the project management system 102. Referring again to FIG. 2, in an embodiment, the project management system 102 may comprise a web page creation module 225, navigation module 240, a communication module 260, a tracking module 265, a link generator module 275, and an investor module 285.

In some embodiments, the project management system 102 communicates with a creator device 120 coupled to and part of the network 190 that execute what is referred to herein as “project creation” software included in the web page creation module 425. The project creation software executing on the project management system 102 empowers a creator device 120 to define projects, described further herein, associated with web pages. For example, the creator device 120 may access the project management system 102 via a browser module 360 of FIG. 2. The project creation software may generate a web page associated with the creator device 120 and store the web page, content, and associated links and network resource identifiers in one or more databases 210. The project creation software may be provided content by the creator device 120 or may retrieve content over the network 190, for example from web servers 290. Where content is so retrieved, it may be associated with network resources available on other devices of the network. As described above, web pages and associated projects hosted by the project management system 102 can later be accessed and interacted with by other users via instructions in the navigation module 240, described further below, to direct them to network resources stored in part in the database 210.

The project management system 102 may also communicate with other networked device to run what is referred to herein as “object navigation” software included in the navigation module 240. The project navigation software may empower user to view and interact with project web pages hosted by the project management system 102. The project navigation software may cause the processor 220 to retrieve the web pages or portions thereof from, for example hosted by the project management system 102.

In an embodiment, interaction with project web pages allows navigation module 240 to use network resource identifiers such as URLs generated and/or stored by the project management system 102 to navigate users to the web page where network resources associated with projects are stored. In an embodiment, the project creation software and/or the project navigation software may be implemented by, for example, a browser executed by a user device.

As described above, the project management system 102 may be connected to or include one or more databases 210. In addition, the database 210 may store data necessary of identifying and locating a user and/or web page as described herein. The database 210 may also store links, network resource identifiers, and other components for hosting personal web pages.

In some embodiments project management system 102 performs a search of users and/or projects and displays results. A user may enter a description or search term in a search field of a web site, and the project navigation software may cause the processor to return search results comprising a list of items (e.g., users or projects with a brief descriptions) having a hyperlink associated with each item. The user may scroll through the search results in order to find a desired item and select the hyperlink to be directed to the web page.

An example search may comprise a fan device 130 may send the search query to the project server node 325. After receiving the search query from, the project management system 102 may leverage a search engine to search the database. The results of the search are sent from the project management system 102 to the fan device 130 and displayed to the user via the browser of the fan device 130. In some embodiments, the user may be able to filter the search results into a list of fewer items. For example, a user may select a category or filter from a drop down menu or presented list for narrowing the search results. These categories may include, but are not limited to, project genres (e.g., horror, comedy, science-fiction, drama, etc.); status of project (e.g., idea only, pre-production, production, distribution, etc.); location of user; project type (e.g., movie, television show, story, etc.), among others. The database 210 may store an association of categories to the various users and/or projects for tracking the user preferences and activity.

Next a user via a user device (e.g., a fan device 130) may select an item from the list of search results. The user device activates a hyperlink associated with the item to retrieve the web page of the selected item. The project server node 325 retrieves the desired web page from the database 210. The retrieved web page or content therein could be retrieved, for example, from web server 290 for example by a browser. Typically, when the network is the Internet as currently configured, the HTML code of such a retrieved web page will include network resource identifiers specifying the domain and pathnames of content files that are to be used by the browser as it assembles the display of the web page at the user device. Network resource identifiers may be accessed by the browser as the web page is executed, and the specified content retrieved by the browser using the network resource identifiers.

Once the display for the web page is assembled by the browser and presented to the user, a user may access additional functionality of the project management system 102. For example, the user device may retrieve code for displaying content of the project via text or embedded hyperlinks to video or audio files.

In an embodiment, instructions in the tracking module 265 may configure the processor 220 to track activity associated with users and/or projects with the project management system 102. For example, a retrieved web page may comprise hyperlinks executable by a user for indicating an interest level in the project. The browser may display a plurality of buttons, each representing an option (as described above) for which a fan device 130 may interact with to indicate an interest level. Information indicative of an executed link may be received and stored in the database 210, which may be used to update an activity log associated with the project stored in the database 210. The activity log may be used to update a rank associated with the project based on a plurality of user selections. In some embodiments, the project rank may be used by the project management system 102 in ranking search results or as a filter category.

In an embodiment, the link generating module 275 may include instructions to cause the processor 220 to generate a unique network resource identifier based at least in part on a fan device 130 and/or a project associated with a retrieved web page. For example, data indicating the user of the fan device 130 may be received along with data indicating the project associated with the retrieved web page. Additionally, information indicating the interest level in the project, as described above, may also be received. In some embodiments, the network resource identifier is a unique URL, for example, a URL including Urchin Tracking Module (UTM) parameters configured to track activity outside of the project management system 102 associated with the project. For example, additional character strings and identifiers may be added to the URL for a given project web page. The additional characters may be used by the tracking module 265 for identifying a fan device 130 or user thereof and/or a project and updating an activity log in the database 210.

The unique network resource identifier may be transmitted to the user via the browser, at which point the user may copy the identifier for subsequent use. For example, the user may provide the unique network resource identifier to other Internet users via, for example, a social network web page. The unique network resource identifier may also be embedded in a hyperlink, that, when executed by another user, directs this user to the project web page identified by the unique network resource identifier. The tracking module 265 may then receive an indicator that the project web page has been accessed based on the unique network resource identifier and updates the activity log of the user and/or project.

As described above, the project management system 102 is configured to facilitate the creation, management, and promotion of projects through interaction and connection between creator device 120 and fan device 130 (and other network connected devices). In some embodiments, the promotion may be through word of mouth via the tracking of user activity on the system. In other embodiments, additional functional may be provided that provides the fan device 130 an option to support the project through financial means. For example, investments by investor device 160 through the investor module 285 may be provided may be tracked and stored for use in determining the activity level of the user.

In an embodiment, instructions in the communication module 260 may cause the processor 220 to establish a direct communication pathway between users of the project management system 102. In some embodiments, the pathway may be based in part on the activity level of one or both users. For example, the processor 220 may retrieve the activity level of a given fan device 120 from the database 210. The processor 220 may also retrieve a threshold value from the database 210. Instructions in the communication module 260 may cause the processor 220 to compare the activity level with the threshold, and if the activity is equal to or greater than the threshold level, an indicator may be generated and stored in the database 210. In some embodiments, this indicator may be representative that the fan device 120 is operated by a “Super Fan,” such that the associated fan is particularly active with the project management system 102. The threshold value may be determined by the operator of the project management system 102. In an embodiment, the threshold may be based on, but not limited to, one or more genres, particular projects, or entire system activity. In an embodiment, the user activity level may also be based on, but not limited to, one or more genres, particular project, or entire system activity. When the projection creation system 110 determines the user activity is at least equal to the threshold value, instructions in the communication module 260 may cause the processor to provide the user with a pathway for directly communicating with creator devices 120. For example, the user may be provided a way to communicate on, but not limited to, a per-project basis, per-genre basis, or all creator devices. The communication pathway may, for example, providing a telephone number, email address, messaging service hosted by the project management system 102, etc. If the activity level of the user is below the threshold, direct communication will be restricted.

While the foregoing description is made in reference to users of a fan device 130, similar functionality and procedures are applicable with other users and devices. For example, activity levels and searching functions may be executed in a similar manner in connection to users of the creator devices 120, provider devices 140, and/or vendor devices 150. The activity levels may be tracked and updated to facilitate the identification of particularly active users and/or users and indicate trustfulness and credibility of the users of the project management system 102.

Those of skill in the art will understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Other Considerations

Any of the components or systems described herein may be controlled by operating system software, such as Windows XP, Windows Vista, Windows 7, Windows 8, Windows Server, UNIX, Linux, SunOS, Solaris, iOS, Android, Blackberry OS, or other similar operating systems. In Macintosh systems, the operating system may be any available operating system, such as MAC OS X. In other embodiments, the components or systems described herein may be controlled by a proprietary operating system. Conventional operating systems control and schedule computer processes for execution, perform memory management, provide file system, networking, I/O services, and provide a user interface, such as a graphical user interface (“GUI”), among other things.

Computing devices, which may comprise the software and/or hardware described above, may be an end user computing device that comprises one or more processors able to execute programmatic instructions. Examples of such computing devices are a desktop computer workstation, a smart phone such as an Apple iPhone or an Android phone, a computer laptop, a tablet PC such as an iPad, Kindle, or Android tablet, a video game console, or any other device of a similar nature. In some embodiments, the computing devices may comprise a touch screen that allows a user to communicate input to the device using their finger(s) or a stylus on a display screen.

The computing devices may also comprise one or more client program applications, such as a mobile “app” (for example, iPhone or Android app) that may be used to visualize data, and initiate the sending and receiving of messages in the computing devices. This app may be distributed (for example downloaded) over the network to the computing devices directly or from various third parties such as an Apple iTunes or Google Play repository or “app store.” In some embodiments, the application may comprise a set of visual interfaces that may comprise templates to display vehicle history reporting and financing information. In some embodiments, as described above, visual user interfaces may be downloaded from another server or service. This may comprise downloading web page or other HTTP/HTTPS data from a web server and rendering it through the “app”. In some embodiments, no special “app” need be downloaded and the entire interface may be transmitted from a remote Internet server to computing device, such as transmission from a web server to an iPad, and rendered within the iPad's browser.

In general, the word “module,” as used herein, refers to logic embodied in hardware or firmware, or to a collection of software instructions, possibly having entry and exit points, written in a programming language, such as, for example, Java, Lua, C or C++, or a user interface provided in conjunction with one or more pieces of hardware. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the project creation system 100, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

In some embodiments, the system distinguishes between the initial transmission of loan application data required for user interfaces, and subsequent transmissions of user interface data so that it may transmit only portions that are necessary to update a vehicle history reporting and financing user interface. This may be done, for example, using an XMLHttpRequest (XHR) mechanism, a data push interface, Asynchronous JavaScript and XML (“Ajax”), or other communication protocols.

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process blocks may be stored, persistently or otherwise, in any type of non-transitory computer storage such as, for example, volatile or non-volatile storage.

The various features and processes described above may be used independently of one another, or may be combined in various ways. All possible combinations and sub combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or blocks. Thus, such conditional language is not generally intended to imply that features, elements and/or blocks are in any way required for one or more embodiments or that one or more embodiments necessarily include logic for deciding, with or without user input or prompting, whether these features, elements and/or blocks are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or blocks in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the project creation system 100, marketing computing device 162, and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

The I/O devices and interfaces provide a communication interface to various external devices and systems. The computing system may be electronically coupled to a network, which comprises one or more of a LAN, WAN, the Internet, or cloud computing networks, for example, via a wired, wireless, or combination of wired and wireless, communication links. The network communicates with various systems or other systems via wired or wireless communication links, as well as various data sources.

Information may be provided to the project management system 102 over the network from one or more data sources including, for example, external sources or internal source information database. The data sources may include one or more internal or external data sources. In some embodiments, one or more of the databases or data sources may be implemented using an open-source cross-platform document-oriented database program, such as a Mongo dB, a relational database, such as IBM DB2, Sybase, Oracle, CodeBase and Microsoft® SQL Server as well as other types of databases such as, for example, a flat file database, an entity-relationship database, and object-oriented database, and/or a record-based database.

It is recognized that the term “remote” may include systems, data, objects, devices, components, or modules not stored locally, that are not accessible via the local bus. Thus, remote data may include a system that is physically stored in the same room and connected to the computing system via a network. In other situations, a remote device may also be located in a separate geographic area, such as, for example, in a different location, country, and so forth.

Those having skill in the art will further appreciate that the various illustrative logical blocks, modules, circuits, and process steps described in connection with the implementations disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. One skilled in the art will recognize that a portion, or a part, may comprise something less than, or equal to, a whole. For example, a portion of a collection of pixels may refer to a sub-collection of those pixels.

The various illustrative logical blocks, modules, and circuits described in connection with the implementations disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or process described in connection with the implementations disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of non-transitory storage medium known in the art. An exemplary computer-readable storage medium is coupled to the processor such the processor can read information from, and write information to, the computer-readable storage medium. In the alternative, the storage medium may be integral to the processor. The processor and the storage medium may reside in an ASIC. The ASIC may reside in a user terminal, camera, or other device. In the alternative, the processor and the storage medium may reside as discrete components in a user terminal, camera, or other device.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure. Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

Headings are included herein for reference and to aid in locating various sections. These headings are not intended to limit the scope of the concepts described with respect thereto. Such concepts may have applicability throughout the entire specification.

The previous description of the disclosed implementations is provided to enable any person skilled in the art to make or use the present invention. Various modifications to these implementations will be readily apparent to those skilled in the art, and the generic principles defined herein may be applied to other implementations without departing from the spirit or scope of the invention. Thus, the present invention is not intended to be limited to the implementations shown herein but is to be accorded the widest scope consistent with the principles and novel features disclosed herein.

What is claimed is:

1. A project processing system, comprising:
a hardware processor configured to execute computer-executable instructions in order to:
store information, received from a first user via a first user device, regarding a first media project in a first database based on account information provided by the first user,
provide a first interface configured to selectively permit the second user to identify an action to perform for the first media project, wherein the action includes viewing the first media project or providing one of financial support, creative input, creative services, and property to the first media project,
provide a prompt to the first user regarding the action identified by the second user,
when the first user accepts the action identified by the second user, store data in the first database regarding the identified action to perform relative to the first media project,
track the first media project within a life cycle including three stages, and
upon determining that the first media project is in a third stage of the life cycle, distribute records from the first database regarding the first media project for a third user to receive.

2. The project processing system of claim 1, wherein the first media project comprises one or more of an image file, a video file, a series of image files, a text file, an audio file, a television program, a series of video files, a video game file, a drawing file, and a combination thereof.

3. The project processing system of claim 1, wherein the processor is further configured to commit transaction information regarding the first media project to a distributed ledger.

4. The project processing system of claim 3, wherein the transaction information includes details regarding storage of the information regarding the first media project in the first database and the identified action performed relative to the first media project.

5. The project processing system of claim 1, further comprising a third database including a third plurality of linked and secured records of a local copy of a distributed ledger, wherein the processor is further configured to commit transaction information regarding the first project to the third database by appending the transaction information to the local copy of the distributed ledger, wherein the transaction information includes details regarding storage of the information regarding the first project in the second database and the identified action performed relative to the first project.

6. The project processing system of claim 5, wherein the processor is further configured to synchronize and validate the third database with the distributed ledger.

7. The project processing system of claim 1, wherein the processor is further configured to provide a second interface, the second interface configured to permit the second user to identify actions available to be performed by the second user for any project associated with the project processing system, the identified actions including providing one of financial support, creative input, creative services, and property.

8. The project processing system of claim 7, wherein the processor is further configured to generate an alert to the second user and wherein the second interface is further configured to permit the second user to provide a bid to the first user in response to the alert, the bid including one of the financial support, the creative input, the creative services, and the property for use in the first project.

9. The project processing system of claim 1, wherein the first interface is further configured to:
selectively permit the second user to access the project processing system via a second user device; and
selectively permit the second user to search for or browse for the first media project.

10. The project processing system of claim 1, wherein the processor is further configured to:
identify a payment associated with the identified action when the action includes providing one of financial support, creative input, creative services, and property to the first media project; and
distribute the payment to the second user based on the determination that the first media project is in the third stage.

11. A method of managing a project, the method comprising:
storing information, received from a first user via a first user device, regarding a first media project in a first database based on account information provided by the first user;
selectively permitting, via a first interface, the second user to identify an action to perform for the first media project, wherein the action includes viewing the first media project or providing one of financial support, creative input, creative services, and property to the first media project;
providing a prompt to the first user regarding the action identified by the second user;
when the first user accepts the action identified by the second user, storing data in the first database regarding the identified action to perform relative to the first media project;
tracking the first media project within a life cycle including three stages; and
upon determining that the first media project is in a third stage of the life cycle, distributing records from the first database regarding the first media project for a third user to receive.

12. The method of claim 11, wherein the first media project comprises one or more of an image file, a video file, a series of image files, a text file, an audio file, a television program, a series of video files, a video game file, a drawing file, and a combination thereof.

13. The method of claim 11, further comprising committing transaction information regarding the first media project to a distributed ledger.

14. The method of claim 13, wherein the transaction information includes details regarding storage of the information regarding the first media project in the first database and the identified action performed relative to the first media project.

15. The method of claim 11, further comprising committing transaction information regarding the first media project to a second database by appending the transaction information to a local copy of a distributed ledger, the second database including linked and secured records of the local copy of the distributed ledger, wherein the transaction information includes details regarding storage of the information regarding the first media project in the first database and the identified action performed relative to the first media project.

16. The method of claim 15, further comprising synchronizing and validating the second database with the distributed ledger.

17. The method of claim 11, further comprising permitting, via a second interface, the second user to identify actions available to be performed by the second user for any media project associated with the project processing system, the identified actions including providing one of financial support, creative input, creative services, and property.

18. The method of claim 17, further comprising generating an alert to the second user and permitting, via the second interface, the second user to provide a bid to the first user in response to the alert, the bid including one of the financial support, the creative input, the creative services, and the property for use in the first project.

19. The method of claim 11, further comprising configured to:
selectively permitting, via the first interface, the second user to access the project processing system via a second user device; and
selectively permitting, via the first interface, the second user to search for or browse for the first media project.

20. The method of claim 11, further comprising:
identifying a payment associated with the identified action when the action includes providing one of financial support, creative input, creative services, and property to the first media project; and
distributing the payment to the second user based on the determination that the first media project is in the third stage.
